(19) United States
(12) Patent Application Publication
(10) Pub. No.: US 2020/0108852 A1
(43) Pub. Date: Apr. 9, 2020

(54) Outrigger sail bike system and apparatus

(71) Applicant: Bradford E. Northup, Santa Ana, CA (US)

(72) Inventor: Bradford E. Northup, Santa Ana, CA (US)

(21) Appl. No.: 16/151,051

(22) Filed: Oct. 3, 2018

(51) Int. Cl. B62B 15/00; B62K 17/00; B62M 6/00

(52) U.S. Cl. CPC B62B 15/005; B62M 6/00; B62K 17/00

(57) ABSTRACT

An outrigger sail vehicle system includes: a vehicle, such as a bicycle; and an outrigger sail device, including a mounting base connected to the vehicle, an outrigger arm rotatably connected to the mounting base, a boom handle rotatably connected to the outrigger arm; a sail assembly, including a sail frame with first and second frame members, and a sail member that is spanned out by the sail frame; whereby, the sail assembly is rotatable from a right to a left side of the vehicle.

### CROSS-REFERENCE TO RELATED APPLICATIONS

N/A.

### FIELD OF THE INVENTION

The present invention relates generally to the field of sail systems for wind propelled motion, and more particularly to methods and systems for outrigger sails for mounting on land-based vehicles, including two-wheeled vehicles, such as bicycles.

### BACKGROUND OF THE INVENTION

There has been a long-standing interest in attaching sails to land based wheeled vehicles, including bicycles.

However, such devices and systems have tended to be large and bulky, with designs that mimic the operation of a sail on a sail boat. As a consequence, such systems are expensive and impractical, and would be unsafe in ordinary use.

As such, considering the foregoing, it may be appreciated that there continues to be a need for novel and improved devices and methods for sails for mounting on vehicles, including two-wheeled vehicles.

### SUMMARY OF THE INVENTION

The foregoing needs are met, to a great extent, by the present invention, wherein in aspects of this invention, enhancements are provided to the existing model of sail systems for mounting on vehicles

In an aspect, an outrigger sail vehicle system can include:
a) a vehicle, which can be a two-wheeled vehicle, such as bicycle; and
b) an outrigger sail device, including:
   i. a mounting base, which can be connected to the vehicle;
   ii. an outrigger arm, such that the outrigger arm can be rotatably connected to the mounting base, such that the outrigger arm can be rotated in a vertical plane from a right to a left side of the mounting base; and
   iii. a boom handle, which is rotatably connected to an outer end of the outrigger arm, such that the boom handle can be rotated in a horizontal plane from an inward inclination angle to an outward inclination angle relative to an elongated direction of the mounting base;
   iv. a sail assembly, which can be connected to the boom handle, the sail assembly including:
      i. a sail frame, which can include a first frame member and a second frame member;
      ii. a sail member, which can be connected to and spanned out by the sail frame;
whereby, when the mounting base is connected to the vehicle, the sail assembly is rotatable from a right side of the vehicle to a left side of the vehicle.

In a related embodiment, the sail member can further include:
a) a sail surface; and
b) a plurality of curved sail spars, which can be connected to an inner side of the sail surface, along a horizontal direction of the sail surface, such that the curved sail spars curve outward, such that an inner side of the sail cloth forms a concave shape in the horizontal direction.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a left side perspective view of an outrigger sail vehicle system, according to an embodiment of the invention.

FIG. 2 is a right side perspective view of an outrigger sail vehicle system, according to an embodiment of the invention.

FIG. 3A is a left side perspective view of parts of an outrigger sail vehicle system, according to an embodiment of the invention.

FIG. 3B is a left side view of parts of an outrigger sail vehicle system, according to an embodiment of the invention.

FIG. 4 is a top view of parts of a sail assembly, according to an embodiment of the invention.

FIG. 5 is a front view of a sail assembly, according to an embodiment of the invention.

FIG. 6 is a top view of a sail assembly, according to an embodiment of the invention.

FIG. 7 is a bottom view of a sail assembly, according to an embodiment of the invention.

FIG. 8 is a front perspective view of a sail assembly, according to an embodiment of the invention.

FIG. 9 is a perspective view of a rear part of a sail assembly, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

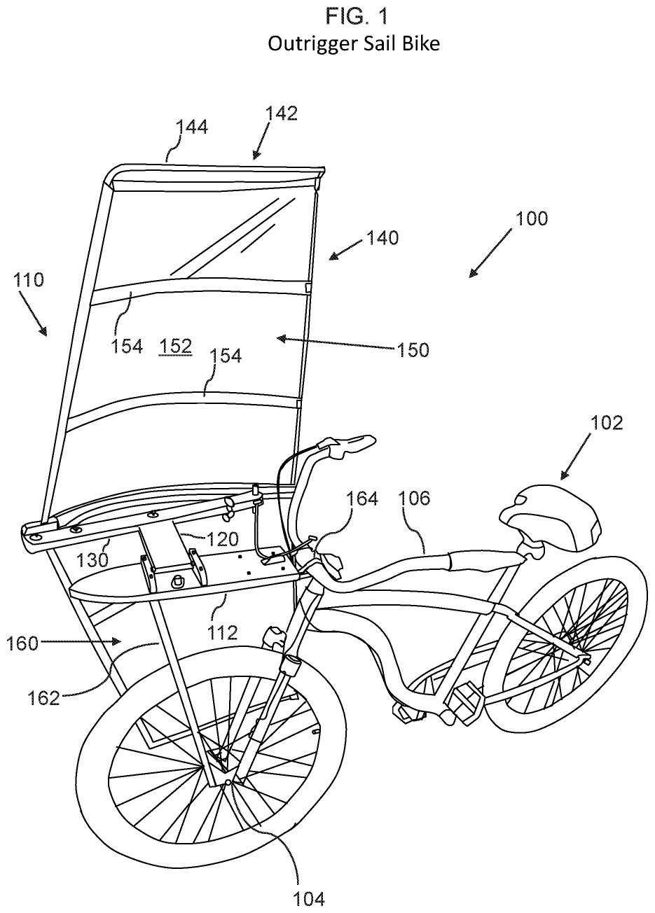

In the following, we describe the structure of an embodiment of a system for an outrigger sail vehicle system 100 with reference to FIG. 1, in such manner that like reference numerals refer to like components throughout; a convention that we shall employ for the remainder of this specification.

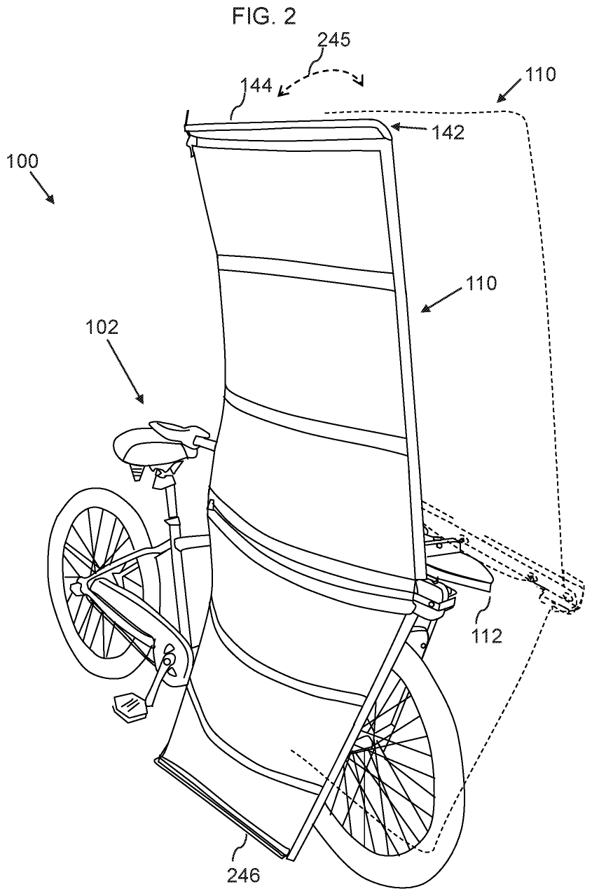

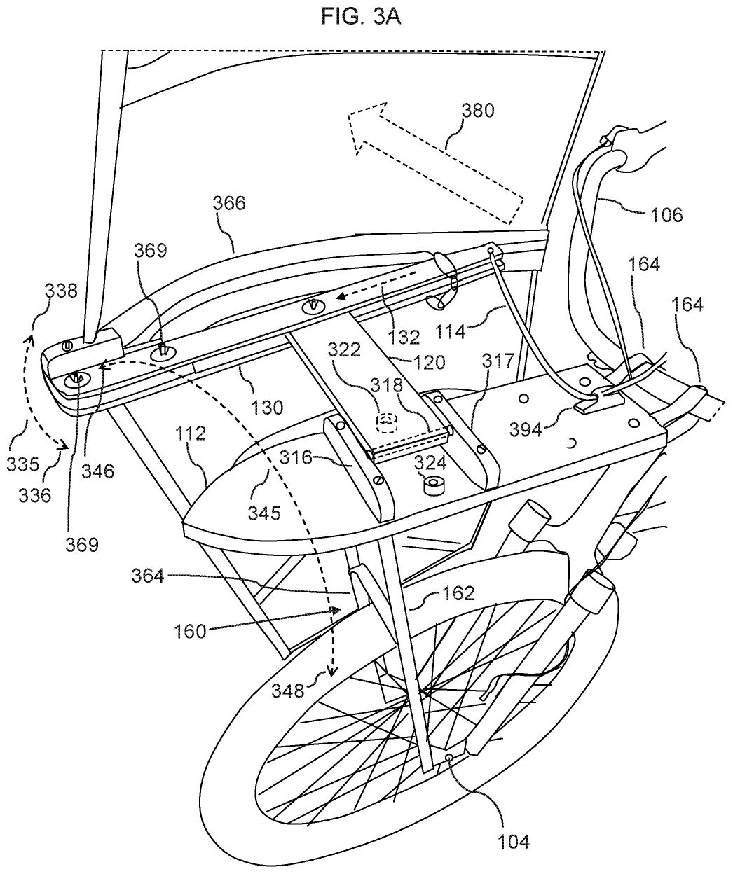

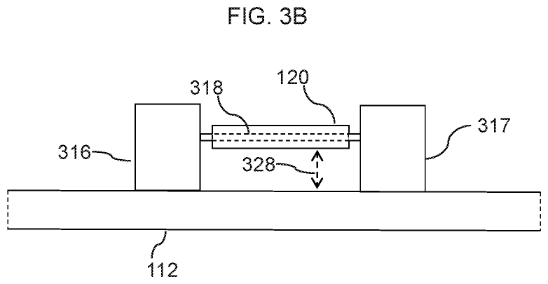

In an embodiment, as shown in FIGS. 1, 2, and 3A, an outrigger sail vehicle system 100 can include:
a) a vehicle 102, which can be a two-wheeled vehicle 102, such as bicycle 102; and
b) an outrigger sail device 110, including:
   v. a mounting base 112, which can be connected to the vehicle 102;
   vi. an outrigger arm 120, such that the outrigger arm 120 can be rotatably connected to the mounting base 112, such that the outrigger arm 120 can be rotated 345 in a vertical plane (i.e. be vertically rotatable 345) from a right to a left side of the mounting base 112; and
   vii. a boom handle 130, which is rotatably connected to an outer end of the outrigger arm 120, such that the boom handle 130 can be rotated horizontally 335 (i.e. be horizontally rotatable 335) from an inward inclination angle 336 to an outward inclination angle 338 relative to an elongated direction 132 of the mounting base 112, as shown in FIG. 3A;
   viii. a sail assembly 140, which can be connected to the boom handle 130, the sail assembly 140 including:
      a sail frame 142, which can include a first frame member 144 and a second frame member 246, as shown in FIG. 2;
      a sail member 150, which can be connected to and spanned out by the sail frame 142;
whereby, when the mounting base 112 is connected to the vehicle 102, such that the outrigger sail device 110 is mounted to the vehicle, the sail assembly 140 is vertically rotatable 345 from a right side 346 of the vehicle to a left side 348 of the vehicle 102. FIG. 2 shows how the outrigger sail device 110 is vertically rotatable 245 from a right to a left side (showing an outline of the outrigger sail device 110 in dotted line on the left side) such that a top of the sail assembly 140 when positioned on the right side is rotated to become a bottom of the sail assembly 140 when the outrigger sail device 110 has been rotated vertically 245 to the left side (corresponding to the vertical rotation 345 shown in FIG. 3).

In various related embodiments, the vehicle 102 can be a snow vehicle 102, such as a mono ski sled 102, bi-ski sled 102, or tri-ski sled 102; a water vehicle 102; or a wheeled land vehicle 102, such as a tricycle 102 or bicycle 102.

In a further related embodiment, as shown in FIGS. 1 and 3A, the outrigger sail device 110 can further include a mounting structure 160 for connecting the mounting base 112 to the vehicle 102, such that the mounting structure 160 can include:
a) a front support structure 162, which can include right and left support members 362 162, which are each connected in a top end to the mounting base 112, and in a rear end to the vehicle 102, such as to an axle 104 of the bicycle 102; and
b) at least one rear connector 164, which connects a rear of the mounting base 112 with the vehicle, such as to a handle 106 of the bicycle 102. The at least one rear connector 164 can be a strap 164, clamp 164, or other type of connector.

In related embodiments, the mounting structure 160 thus resembles structures or parts for securely mounting a front cargo rack on a bicycle.

In a related embodiment, the sail member 150 can further include:
a) a sail surface 152 (which can also be called a sail sheet 152 or sail structure 152), which can be made of or a flexible material such as cloth, to form a sail cloth 152, but alternatively can be rigid; and
b) a plurality of curved sail spars 154, which can be connected to an inner side of the sail surface 152, along a horizontal direction of the sail surface 152, such that the curved sail spars 154 curve outward, such that an inner side of the sail cloth 152 forms a concave shape in the horizontal direction.

In another related embodiment, as shown in FIG. 3A, the outrigger sail device 110 can further include an adjustable strap 114 and a releasable strap lock 394, such that a rear end of the boom handle 130 can be connected to the mounting base 112 with the adjustable strap 114, such that an open end of the adjustable strap 114 protrudes through the releasable strap lock 394, such that the adjustable strap is configured to be length adjustable via the releasable strap lock 394, such that pulling on an open end of the adjustable strap 114 moves the sail assembly 140 to an outward inclination angle 338 and releasing the open end of the adjustable strap 114 moves the sail assembly 140 to an inward inclination angle 336 when there is a wind pressure 380 on an inner side of the sail member 150.

In another related embodiment, as shown in FIG. 3A, the outrigger sail device 110 can further include front and rear flanges 316 317 mounted on an upper side of the mounting base 112, and a rotational axle 318 that is mounted between the front and rear flanges 316 317, such that the rotational axle 318 penetrates an inner end of the outrigger arm 120; such that the outrigger arm 120 is configured to be rotatable, either by rotating around the rotational axle 318 or such that the rotational axle 318 is rotatable relative to the front and rear flanges 316 317, such that the rotational axle 318 is configured with a sufficient separation distance 328 from the mounting base 112 to allow unimpeded rotation of the outrigger arm 120, as shown in FIG. 3B. The outrigger sail device 110 can further include right and left stop blocks 322 324 mounted on an upper side of the mounting base 112 respectively to a right and left side of the rotational axle 118, such that the right and left stop blocks 322 324 are configured to stop the outrigger arm 120 in a horizontal position on respectively a right and left side of the mounting base 112.

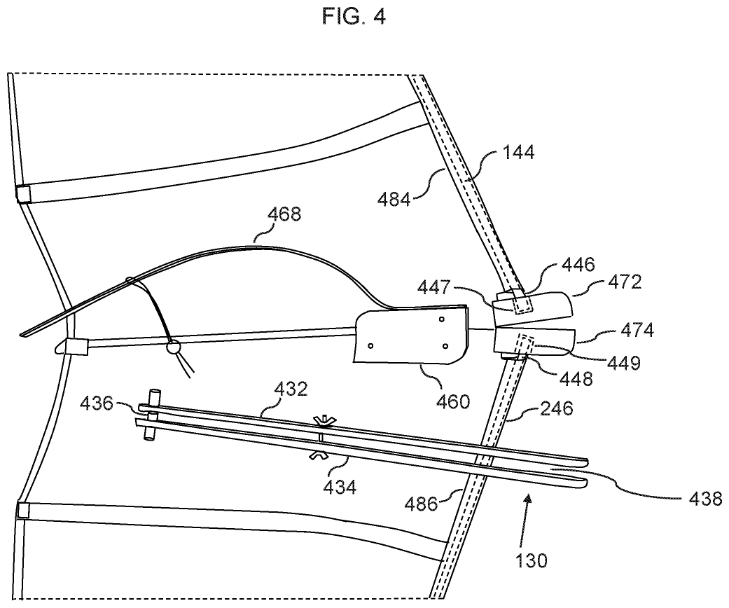

In yet another related embodiment, as shown in FIG. 4, the boom handle 130 can include first and second boom members 432 434, which can be parallel along an elongated direction, and connected in a rear end by a rear separation block 436, such that there is a separation gap 438 between the first and second boom members 432 434.

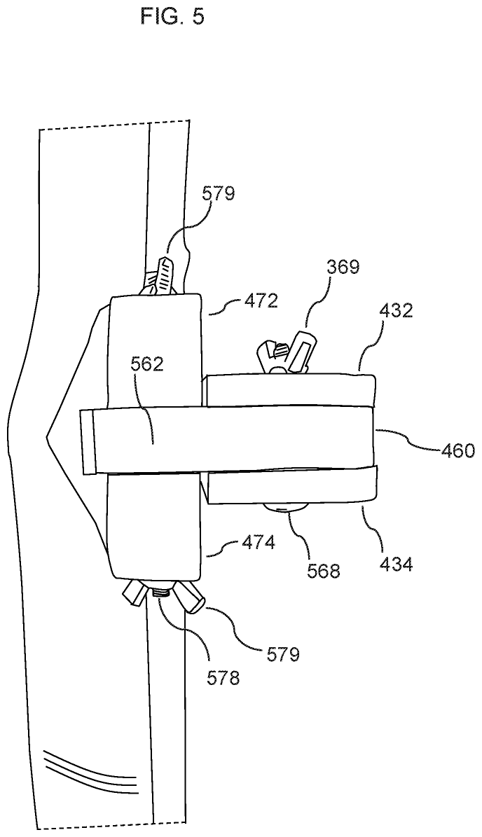

In a further related embodiment, as shown in FIG. 4, the sail assembly 140 can further include:
a) a lock block 460;
b) a suspension spar 468; such that an inner side of a front end of the suspension spar 468 is connected to an outer side of the lock block 460, such a rear end of the suspension spar 468 is curved;
c) a first mast base 472; and
d) a second mast base 474;
wherein the suspension spar 468 is connected to a central portion of the sail surface 152, and positioned along a horizontal direction of the sail cloth 152, such that the suspension spar 468 curves outward, to match the concave shape of the sail surface 152;
wherein the lock block 460 is mounted between front parts of the first and second boom members 432 434, for example with bolts 568 and wingnuts 369 as shown in FIGS. 3 and 5, such that a protruding portion 562 of the lock block 360 protrudes to an outer side of the first and second boom members 432 434, as shown in FIG. 5;
wherein the first and second mast bases 472 474 are mounted on respectively upper and lower sides of the protruding portion 562 of the lock block 460 for example with bolts 578 and wingnuts 579; and
wherein an inner end 446 (also referred to as a first/lower end 446) of the first frame member 144 is inserted into a first base aperture 447 on a first side of the first mast base 372; and an inner end 448 (also referred to as a second/upper end 448) of the second frame member 246 is inserted into a second base aperture 449 on a second side of the second mast base 374. As shown in FIGS. 2 and 4, lower parts the first and second sail frame members 144 246 can be inserted into respective pouches 484 486 on a front of the sail surface 152.

In a related embodiment, FIG. 5 shows that one threaded bolt 578 with wingnuts 579 holds both mast bases 472 474 to the lock block 460.

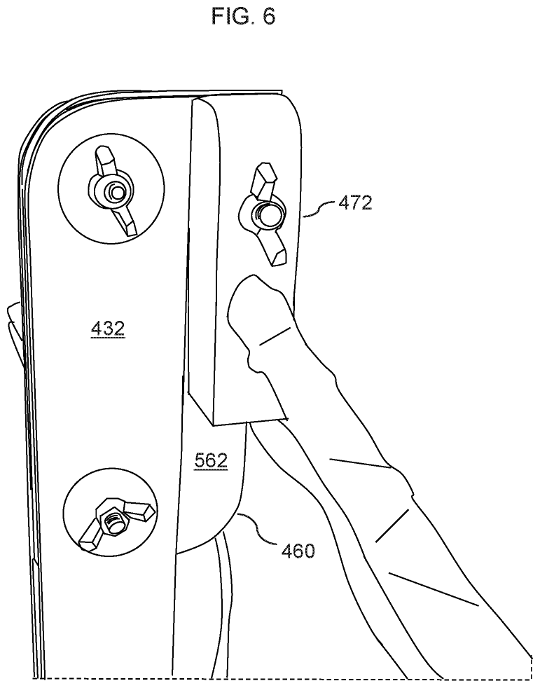

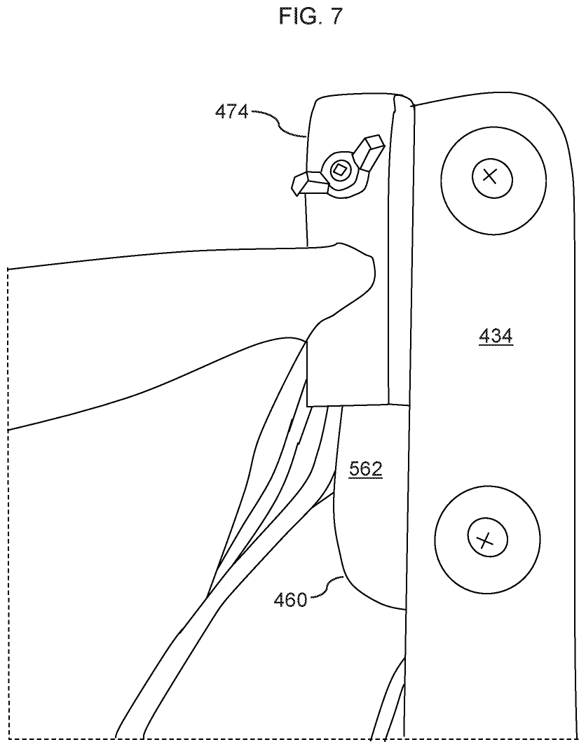

In another related embodiment, FIGS. 6 and 7 shows that the boom handle will not allow the mast base to pivot or twist.

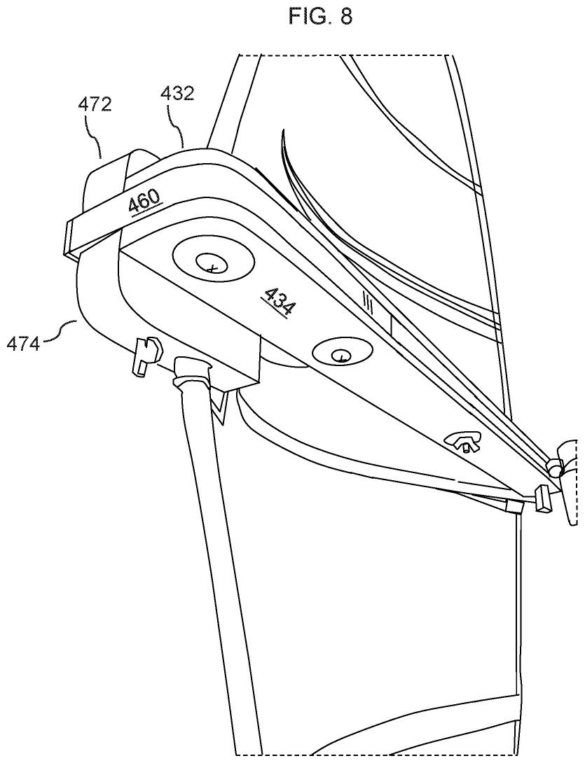

In another related embodiment, FIG. 8 shows how the boom handle sandwiches the lock block and does not allow the mast base to turn or twist.

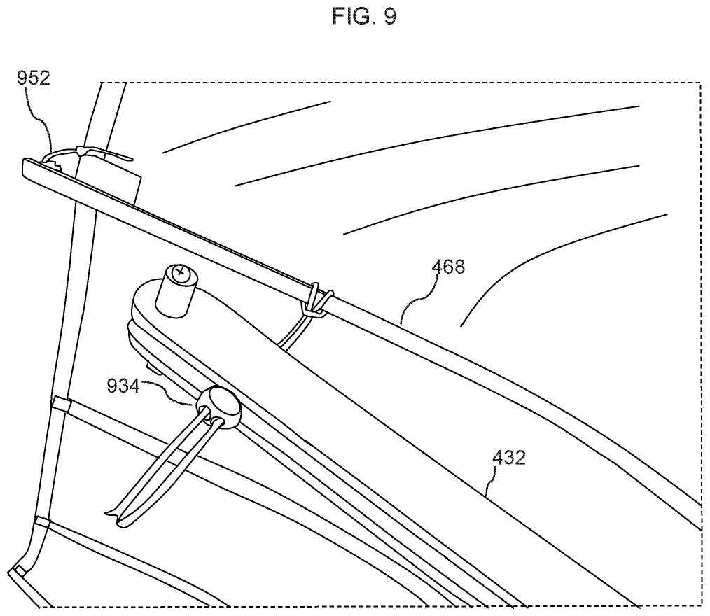

In a related embodiment, as shown in FIG. 9, a rear end of the suspension spar 468 can be connected to a rear end of the sail member 150, for example with a connection strap 952. Alternatively, as shown in FIG. 3A, the suspension spar 468 can be inserted into an elongated pouch 366 mounted on an inside of the sail member 150, in a horizontal direction of the sail member.

In a related embodiment, as shown in FIG. 9, a rear portion of the suspension spar 468 can be connected to a rear end of the boom handle 130 with a connection strap 952, wherein an open end of the connection strap 952 protrudes through a releasable strap lock 934, such that the connection strap 952 can be length adjustable via the releasable strap lock 934.

Here has thus been described a multitude of embodiments of the outrigger sail vehicle system 100, the outrigger sail device 110, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. An outrigger sail vehicle system, comprising:
a) a vehicle; and
b) an outrigger sail device, including:
a mounting base, which is connected to the vehicle;
an outrigger arm, such that the outrigger arm is rotatably connected to the mounting base, such that the outrigger arm is vertically rotatable from a right to a left side of the mounting base;
a boom handle, which is rotatably connected to an outer end of the outrigger arm, such that the boom handle is horizontally rotatable from an inward inclination angle to an outward inclination angle relative to an elongated direction of the mounting base; and
a sail assembly, which is connected to the boom handle, the sail assembly comprising:
a sail frame; and
a sail member, which is connected to and spanned out by the sail frame;
such that the sail assembly is rotatable from a right side of the vehicle to a left side of the vehicle.

2. The outrigger sail vehicle system of claim 1, wherein the sail frame comprises a first frame member and a second frame member, such that the first and second frame members are connected.

3. The outrigger sail vehicle system of claim 1, wherein the sail member further comprises:
a) a sail surface; and
b) a plurality of curved sail spars, which are connected to the sail surface, along a horizontal direction of the sail surface, such that the curved sail spars curve outward, such that an inner side of the sail surface forms a concave shape in the horizontal direction.

4. The outrigger sail vehicle system of claim 1, wherein the outrigger sail device further comprises:
a) an adjustable strap; and
b) a releasable strap lock;
wherein a rear end of the boom handle is connected to the mounting base with the adjustable strap, such that an open end of the adjustable strap protrudes through the releasable strap lock, such that the adjustable strap is configured to be length adjustable via the releasable strap lock, such that pulling on an open end of the adjustable strap moves the sail assembly to the outward inclination angle and releasing the open end of the adjustable strap moves the sail assembly to the inward inclination angle, when there is a wind pressure on an inner side of the sail member.

5. The outrigger sail vehicle system of claim 2, wherein the outrigger sail device further comprises:
a) the boom handle comprising first and second boom members, which are parallel along an elongated direction;
b) a rear separation block, such that the first and second boom members are connected in a rear end by the rear separation block such that there is a separation gap between the first and second boom members;
c) a lock block;
d) a first mast base having a first base aperture on a first side of the first mast base; and
e) a second mast base having a second base aperture on a second side of the second mast base;
wherein the lock block is mounted between front parts of the first and second boom members, such that a protruding portion of the lock block protrudes to an outer side of the first and second boom members;
wherein the first and second mast bases are mounted on respectively upper and lower sides of the protruding portion of the lock block; and
wherein an inner end of the first frame member is inserted into the first base aperture on the first side of the first mast base; and an inner end of the second frame member is inserted into the second base aperture on the second side of the second mast base.

6. The outrigger sail vehicle system of claim 5, wherein the outrigger sail device further comprises:
a suspension spar, such that an inner side of a front end of the suspension spar is connected to an outer side of the lock block, wherein a rear portion of the suspension spar is curved;
wherein the suspension spar is connected to the sail member and positioned along a horizontal direction of the sail member, such that the suspension spar curves outward, to match a concave shape in the horizontal direction of the sail member.

7. An outrigger sail vehicle system, comprising:
an outrigger sail device, including:
a mounting base, which is configured to connect to a vehicle;
an outrigger arm, such that the outrigger arm is rotatably connected to the mounting base, such that the outrigger arm is vertically rotatable from a right to a left side of the mounting base; and
a sail assembly, which is connected to an outer end of the outrigger arm, the sail assembly comprising:
a sail frame; and
a sail member, which is connected to and spanned out by the sail frame;
whereby the sail assembly is rotatable from a right side of the vehicle to a left side of the vehicle, when the mounting base is connected to the vehicle.

8. The outrigger sail vehicle system of claim 7, wherein the outrigger sail device further comprises:
a boom handle, which is rotatably connected to the outer end of the outrigger arm, such that the boom handle is horizontally rotatable from an inward inclination angle to an outward inclination angle relative to an elongated direction of the mounting base;
wherein the sail assembly is connected to the boom handle, such that the sail assembly is connected to the outer end of the outrigger arm via the boom handle.

9. The outrigger sail vehicle system of claim 8, wherein the sail frame comprises a first frame member and a second frame member, such that the first and second frame members are connected.

10. The outrigger sail vehicle system of claim 7, wherein the sail member further comprises:
a) a sail surface; and
b) a plurality of curved sail spars, which are connected to the sail surface, along a horizontal direction of the sail surface, such that the curved sail spars curve outward, such that an inner side of the sail surface forms a concave shape in the horizontal direction.

11. The outrigger sail vehicle system of claim 10, wherein the sail surface is made of a flexible material.

12. The outrigger sail vehicle system of claim 8, wherein the outrigger sail device further comprises:
a) an adjustable strap; and
b) a releasable strap lock;
wherein a rear end of the boom handle is connected to the mounting base with the adjustable strap, such that an open end of the adjustable strap protrudes through the releasable strap lock, such that the adjustable strap is configured to be length adjustable via the releasable strap lock, such that pulling on an open end of the adjustable strap moves the sail assembly to the outward inclination angle and releasing the open end of the adjustable strap moves the sail assembly to the inward inclination angle, when there is a wind pressure on an inner side of the sail member.

13. The outrigger sail vehicle system of claim 7, wherein the outrigger sail device further comprises:
a) front and rear flanges, which are mounted on an upper side of the mounting base; and
b) a rotational axle, which is mounted between the front and rear flanges, such that the rotational axle penetrates an inner end of the outrigger arm;
such that the rotational axle is configured with a separation distance from the mounting base to allow unimpeded rotation of the outrigger arm.

14. The outrigger sail vehicle system of claim 13, wherein the outrigger sail device further comprises first and second stop blocks, which are mounted on an upper side of the mounting base, respectively to a right and left side of the rotational axle, such that the right and left stop blocks are configured to stop the outrigger arm in a horizontal position on respectively a right and left side of the mounting base.

15. The outrigger sail vehicle system of claim 9, wherein the outrigger sail device further comprises:
a) the boom handle comprising first and second boom members, which are parallel along an elongated direction;
b) a rear separation block, such that the first and second boom members are connected in a rear end by the rear separation block such that there is a separation gap between the first and second boom members;
c) a lock block;
d) a first mast base having a first base aperture on a first side of the first mast base; and
e) a second mast base having a second base aperture on a second side of the second mast base;
wherein the lock block is mounted between front parts of the first and second boom members, such that a protruding portion of the lock block protrudes to an outer side of the first and second boom members;
wherein the first and second mast bases are mounted on respectively upper and lower sides of the protruding portion of the lock block; and
wherein an inner end of the first frame member is inserted into the first base aperture on the first side of the first mast base; and an inner end of the second frame member is inserted into the second base aperture on the second side of the second mast base.

16. The outrigger sail vehicle system of claim 15, wherein the outrigger sail device further comprises:
a suspension spar, such that an inner side of a front end of the suspension spar is connected to an outer side of the lock block, wherein a rear portion of the suspension spar is curved;
wherein the suspension spar is connected to the sail member and positioned along a horizontal direction of the sail member, such that the suspension spar curves outward, to match a concave shape in the horizontal direction of the sail member.

17. The outrigger sail vehicle system of claim 16, wherein the outrigger sail device further comprises:
a connection strap;
wherein a rear end of the suspension spar is connected with the connection strap to a rear end of the sail member.

18. The outrigger sail vehicle system of claim 16, wherein the outrigger sail device further comprises:
an elongated pouch, which is mounted on the sail member, in a horizontal direction of the sail member;
wherein the suspension spar is inserted into the elongated pouch.

19. The outrigger sail vehicle system of claim 16, wherein the outrigger sail device further comprises:
a) a connection strap; and
b) a releasable strap lock;
wherein a rear portion of the suspension spar is connected to a rear end of the boom handle with the connection strap, wherein an open end of the connection strap protrudes through the releasable strap lock, such that the connection strap is length adjustable.

20. The outrigger sail vehicle system of claim 7, further comprising
the vehicle, wherein the vehicle is a bicycle;
wherein the mounting base is connected to the bicycle.
